(19) United States
(12) Patent Application Publication
(10) Pub. No.: US 2014/0373935 A1
(43) Pub. Date: Dec. 25, 2014

(54) GAS BRANCHED FLOW SUPPLYING APPARATUS FOR SEMICONDUCTOR MANUFACTURING EQUIPMENT

(71) Applicant: FUJIKINN INCORPORATED, Osaka (JP)

(72) Inventors: Kouji Nishino, Osaka (JP); Ryousuke Dohi, Osaka (JP); Nobukazu Ikeda, Osaka (JP); Kaoru Hirata, Osaka (JP); Kazuyuki Morisaki, Osaka (JP)

(73) Assignee: Fujikin Incorporated, Osaka (JP)

(21) Appl. No.: 14/375,758

(22) PCT Filed: Oct. 17, 2012
(86) PCT No.: PCT/JP2012/006626

§ 371 Date: Jul. 30, 2014

(30) Foreign Application Priority Data
Jan. 30, 2012 (JP) 2012-016266

(51) Int. Cl. G05D 7/06

(52) U.S. Cl. CPC G05D 7/0641
USPC 137/102

(57) ABSTRACT

A gas branched flow supplying apparatus for semiconductor manufacturing equipment. An arithmetic and control unit 7 works to successively open the respective branched pipe passage opening/closing valves 10a, 10n for a predetermined time and then close the valves, and the gas branched flow supplying apparatus performs flow control of the process gas distributed through the orifice 6 by the pressure type flow control unit 1a, and branches and supplies the process gas by opening and closing the branched pipe passage opening/closing valves 10a, 10n.

This is a National Phase Application in the United States of International Patent Application No. PCT/JP2012/006626 filed Oct. 17, 2012, which claims priority on Japanese Patent Application No. JP2012-016266, filed Jan. 30, 2012. The entire disclosures of the above patent applications are hereby incorporated by reference.

The present invention relates to an improvement in a gas supplying apparatus for semiconductor manufacturing equipment, and specifically, to a gas branched flow supplying apparatus for semiconductor manufacturing equipment that includes a plurality of high-speed opening/closing valves joined in parallel on the downstream side of a pressure type flow control system, and by controlling the opening and closing order and the opening and closing times of the respective high-speed opening/closing valves, accurately branches and supplies required amounts of a process gas to a plurality of process chambers that perform the same process, and by organically combining a thermal type flow control system with the pressure type flow control system, it is enabled to arbitrarily check an actual flow rate of the process gas during branched flow supply.

In the gas supplying apparatus for a semiconductor control device, conventionally, a thermal type flow control system and a pressure type flow control system FCS are widely used.

FIG. 8 shows a structure of a pressure type flow control system used in the gas supplying apparatus, and this pressure type flow control system FCS includes a control valve CV, a temperature detector T, a pressure detector P, an orifice OL, and an arithmetic and control unit CD, etc., and the arithmetic and control unit CD includes a temperature correction/flow rate arithmetic circuit CDa, a comparison circuit CDb, an input-output circuit CDc, and an output circuit CDd, etc.

In this pressure type flow control system, detection values from the pressure detector P and the temperature detector T are converted into digital signals and input into the temperature correction/flow rate arithmetic circuit CDa, and here, temperature correction of the detected pressure and flow rate computation are performed, and then, a computed flow rate value Qt is input into the comparison circuit CDb. On the other hand, a set flow rate input signal Qs is input from the terminal In, converted into a digital value in the input-output circuit CDc, and then input into the comparison circuit CDb, and here, compared with the computed flow rate value Qt from the temperature correction/flow rate arithmetic circuit CDa. When a set flow rate input signal Qs is larger than the computed flow rate value Qt, a control signal Pd is output to the drive unit of the control valve CV, and the control valve CV is driven in an opening direction via a drive mechanism CVa thereof. That is, the control valve is driven in the valve opening direction until the difference (Qs−Qt) between the set flow rate input signal Qs and the arithmetic flow rate value Qt becomes zero.

The pressure type flow control system FCS itself is known, and has excellent characteristics in which, between the downstream side pressure P₂ of the orifice OL (that is, the pressure P₂ on the process chamber side) and the upstream side pressure P₁ of the orifice OL (that is, the pressure P₁ on the outlet side of the control valve CV), when the relationship of P₁/P₂≧approximately 2 (hereinafter, the so-called critical expansion condition) is held, the flow rate Q of the gas Go distributed through the orifice OL satisfies Q=KP₁ (herein, K is a constant), and by controlling the pressure P₁, the flow rate Q can be controlled with high accuracy, and even if the pressure of the gas G₀ on the upstream side of the control valve CV greatly changes, the controlled flow rate value hardly changes.

Thus, in the gas supply equipment for semiconductor manufacturing equipment of a type that branches and supplies a gas to one or a plurality of process chambers, as shown in FIG. 9 and FIG. 10, for respective supply lines GL₁ and GL₂, pressure type flow control systems FCS₁ and FCS₂ are provided, respectively, and accordingly, the gas flow rates Q₁ and Q₂ of the respective supply lines GL₁ and GL₂ are regulated.

Therefore, the pressure type flow control system must be installed for each branched flow passage of the process gas, so that there is a basic problem in which downsizing and reductions in the cost of the gas supplying apparatus for semiconductor manufacturing equipment are difficult.

In FIG. 9, the reference symbol S denotes a gas supply source, G denotes a process gas, C denotes a chamber, D denotes a two-divided gas discharging device, H denotes a wafer, I denotes a wafer holding base (Japanese Published Unexamined Patent Application No. 2008-009554), and in FIG. 10, the reference symbol RG denotes a pressure regulator, MFM₁ and MFM₂ denote thermal type flowmeters, P₂A, P₂B, and P₁ denote pressure gauges, V₁, V₂, V₃, V₄, VV₁, and VV₂ denote valves, and VP₁ and VP₂ denote exhaust pumps (Japanese Published Unexamined Patent Application No. 2000-305630).

To solve the problem described above in the gas supplying apparatus shown in FIG. 9 and FIG. 10, as shown in FIG. 11, a branched flow supplying apparatus is developed in which sonic nozzles or orifices SN₁ and SN₂ are interposed in the respective branched gas supply lines GL₁ and GL₂, and by holding the primary side pressure P₁ of each of the orifices SN₁ and SN₂ to be approximately three times as high as the secondary side pressure P₂ of each of the orifices SN₁ and SN₂ by regulating the automatic pressure controller ACP provided on the gas supply source side by a control unit ACQ, predetermined branched flow rates Q₁ and Q₂ determined according to the diameters of the orifices SN₁ and SN₂ are obtained (Japanese Published Unexamined Patent Application No. 2003-323217).

However, in the flow control system (branched flow supplying apparatus) disclosed in Japanese Published Unexamined Patent Application No. 2003-323217 described above, the automatic pressure controller ACP, the control unit ACQ, and the orifices SN₁ and SN₂ are installed individually, and the primary side pressure P₁ is set to three times as high as the secondary side pressure P₂ to make the flow rates Q₁ and Q₂ proportional to the primary side pressure P₁, and the gas flows that are distributed through the orifices SN₁ and SN₂ are made as flows in the critical states.

As a result, it is necessary to appropriately assemble and integrate the automatic pressure controller ACP, the control unit ACQ, and the orifices SN₁ and SN₂, etc., so that manufacturing of the gas supplying apparatus becomes troublesome, and in addition, it is difficult to downsize and compactify the gas supplying apparatus.

In addition, the control system of the control unit ACQ and the automatic pressure controller ACP does not adopt so-called feedback control, and as a result, it becomes difficult for the automatic pressure controller ACP to swiftly adjust the fluctuation of the primary side pressure P₁ caused by opening and closing operations of the opening/closing valves V₁ and V₂, and the flow rate Q₁ (or flow rate Q₂) easily fluctuates.

Further, the primary side pressure P₁ is regulated by the automatic pressure controller ACP, and in a state where the ratio P₁/P₂ of the primary side pressure P₁ to the secondary side pressure P₂ of the orifice is held at approximately 3 or more, the branched flow rates Q₁ and Q₂ are controlled, so that when the value of P₁/P₂ approaches approximately 2 and the gas flow becomes a gas flow under a so-called non-critical expansion condition, accurate branched flow control becomes difficult.

In addition, for switching control of the respective branched flow passages for supplying the flow rates Q₁ and Q₂, opening/closing valves V₁ and V₂ are always necessary in addition to the orifices SN₁ and SN₂, so that it is difficult to realize downsizing and compactification and a significant reduction in manufacturing cost of the gas supplying equipment.

### CITATION LIST

### Patent Documents

Patent Document 1: Japanese Published Unexamined Patent Application No. 2008-009554

Patent Document 2: Japanese Published Unexamined Patent Application No. 2000-305630

Patent Document 3: Japanese Published Unexamined Patent Application No. 2003-323217

### SUMMARY OF THE INVENTION

Various embodiments of the present invention solve the above-described problems in a gas branched flow supplying apparatus using a conventional pressure type flow control system, that is, (a) downsizing and reductions in the cost of the gas supplying apparatus are difficult when the pressure type flow control system is provided for each gas supply line (each branched flow line), (b) when the primary side pressure P₁ of each orifice is regulated by an automatic pressure controller provided on the gas supply source side, and the respective branched gas flow rates Q₁ and Q₂ in proportion to the pressure P₁ are supplied through the respective orifices, assembling and manufacturing of the gas supplying apparatus are troublesome and downsizing and compactification of the apparatus are difficult, when any of the branched flow passages is opened or closed, the orifice primary side pressure P₁ fluctuates and the branched flow rate of the other branched flow passage (or passages) easily fluctuates, and it becomes difficult to control the branched flow rates Q₁ and Q₂ with high accuracy when the ratio P₁/P₂ of the orifice primary side pressure P₁ to the secondary side pressure P₂ becomes a value (for example, approximately 2 or less in the case of O₂ or N₂) out of the critical expansion condition, etc., and by using a gas branched flow supplying apparatus structurally simplified and downsized, the present invention provides a gas branched flow supplying apparatus for semiconductor manufacturing equipment which can divide and supply a process gas to a number of process chambers performing the same process economically while performing highly accurate flow control, and by organically integrating a pressure type flow control system and a thermal type flow control system, can perform highly accurate branched flow supply even in a state out of the critical expansion condition, and arbitrarily perform actual flow rate monitoring of the process gas being supplied as necessary.

As a means for solving the problems, first, the inventors of the present application conceived of a system that supplies the same amounts of gas to the respective branched flow passages per unit time by controlling the supply flow rate from the gas supply source by the pressure type flow control system and supplying the gas at the controlled flow rate to the plurality of branched flow passages while switching the branched flow passages at each short amount of time. That is, a pressure type flow control system is constructed in which the respective orifices SN₁ and SN₂ in the gas supply system described in FIG. 11 are removed, and one orifice is provided on the downstream side of the automatic pressure controller ACP, and by automatically switching the respective opening/closing valves V₁ and V₂ alternately at each short amount of time, a flow rate of ½ (when the number of branched flow passages is 2) of the flow-out flow rate Q from the pressure type flow control system is supplied to each branched flow passage.

Simultaneously with this, the inventors repeatedly investigated the relationship between actual supply modes of the process gas to process chambers for semiconductor manufacturing equipment and the results of process treatment, etc.

As a result, it was found that the supply of the process gas to the process chambers does not have to be always at a constant uniform flow rate, and keeping of the total supply amount of the process gas in a predetermined time at a set value is the most important element in process treatment.

That is, even a gas supply mode in which the process gas is intermittently supplied to the respective branched flow passages by automatically switching the opening/closing valves V₁ and V₂ described above alternately at each short amount of time can be sufficiently put into practical use as long as the total gas supply amount to be supplied to the respective branched flow passages in a predetermined time can be controlled to a set value with high accuracy.

The present invention was made based on the above-described idea of the inventors and the results of various tests, and as a basic constitution of the invention according to a first aspect, a gas branched flow supplying apparatus for semiconductor manufacturing equipment includes a control valve 3 forming a pressure type flow control unit 1a connected to a process gas inlet 11, a gas supply main pipe 8 communicatively connected to the downstream side of the control valve 3, an orifice 6 provided in the gas supply main pipe 8 on the downstream side of the control valve 3, a plurality of branched pipe passages 9a, 9n connected in parallel on the downstream side of the gas supply main pipe 8, branched pipe passage opening/closing valves 10a, 10n interposed in the respective branched pipe passages 9a, 9n, a pressure sensor 5 provided in the process gas passage between the control valve 3 and the orifice 6, branched gas flow outlets 11a, 11 n provided on the outlet sides of the respective branched pipe passages 9a, 9n, and an arithmetic and control unit 7 into which a pressure signal from the pressure sensor 5 is input, and which computes a total flow rate Q of the process gas distributed through the orifice 6 and outputs a control signal Pd to a valve drive unit 3a to operate the control valve 3 to open and close in a direction in which the difference between the computed flow rate value and a set flow rate value decreases, and outputs opening-closing control signals Oda, Odn to the branched pipe passage opening/closing valves 10a, 10n to successively open the respective branched pipe passage opening/closing valves 10a, 10n for a predetermined time and then close the valves, and the gas branched flow supplying apparatus performs flow control of the process gas distributed through the orifice 6 by the pressure type flow control unit 1a, and branches and supplies the process gas by opening and closing the branched pipe passage opening/closing valves 10a, 10n.

As a basic constitution of the invention according to a second aspect, a gas branched flow supplying apparatus for semiconductor manufacturing equipment includes a control valve 3 constituting a pressure type flow control unit 1a connected to a process gas inlet 11, a thermal type flow sensor 2 constituting a thermal type flow control unit 1b connected to the downstream side of the control valve 3, a gas supply main pipe 8 communicatively connected to the downstream side of the thermal type flow sensor 2, a plurality of branched pipe passages 9a, 9n connected in parallel on the downstream side of the gas supply main pipe 8, branched pipe passage opening/closing valves 10a, 10b interposed in the respective branched pipe passages 9a and 9n, an orifice 6 provided in the gas supply main pipe 8 on the downstream side of the control valve 3, a temperature sensor 4 provided near a process gas passage between the control valve 3 and the orifice 6, a pressure sensor 5 provided in the process gas passage between the control valve 3 and the orifice 6, branched gas flow outlets 11a, 11n provided on the outlet sides of the branched pipe passages 9a, 9n, and an arithmetic and control unit 7 including a pressure type flow rate arithmetic and control unit 7a into which a pressure signal from the pressure sensor 5 and a temperature signal from the temperature sensor 4 are input, and which computes a total flow rate Q of the process gas distributed through the orifice 6 and outputs a control signal Pd to a valve drive unit 3a to operate the control valve 3 to open and close in a direction in which the difference between the computed flow rate value and a set flow rate value decreases, and outputs opening-closing control signals Oda, Odn to the branched pipe passage opening/closing valves 10a, 10n to successively open the respective branched pipe passage opening/closing valves 10a, 10n for a predetermined time and then close the valves, and a thermal type flow rate arithmetic and control unit 7b into which a flow rate signal 2c from the thermal type flow sensor 2 is input, and which computes and displays a total flow rate Q of the process gas distributed through the gas supply main pipe 8 from the flow rate signal 2c, and the gas branched flow supplying apparatus performs process gas flow control by the pressure type flow control unit 1a when the process gas flow distributed through the orifice 6 is a gas flow satisfying the critical expansion condition and performs process gas flow control by the thermal type flow control unit 1b when the process gas flow is a gas flow not satisfying the critical expansion condition, and branches and supplies the process gas by opening and closing the branched pipe passage opening/closing valves 10a, 10n.

The invention according to a third aspect is the invention according to the first or second aspect, characterized in that the opening times of the plurality of branched pipe passage opening/closing valves 10a, 10n are set equal to each other, and process gas Qa, Qn at the same flow rate are supplied to the respective branched pipe passages 9a, 9n.

The invention according to a fourth aspect is the invention according to the first or second aspect which is characterized in that a process gas is distributed through only an arbitrary branched pipe passage (or passages) of the plurality of branched pipe passages 9a, 9n.

The invention according to a fifth aspect is the invention according to the first aspect, characterized in that the control valve 3, the orifice 6, the pressure sensor 5, the temperature sensor 4, the branched pipe passages 9a, 9n, the branched pipe passage opening/closing valves 10a, 10n, and the gas supply main pipe 8 are integrally formed and assembled in one body.

The invention according to a sixth aspect is the invention according to the second aspect, characterized in that the control valve 3, the thermal type flow sensor 2, the orifice 6, the pressure sensor 5, the temperature sensor 4, the gas supply main pipe 8, the branched pipe passages 9a, 9n, and the branched pipe passage opening/closing valves 10a, 10n are integrally formed and assembled in one body.

The invention according to a seventh aspect is the invention according to the second aspect, characterized in that the flow rate of the process gas is controlled by the pressure type flow control unit 1a, and the actual flow rate of the process gas is displayed by the thermal type flow control unit 1b.

The invention according to an eighth aspect is the invention according to the second aspect, characterized in that the pressure sensor 5 is provided between the outlet side of the control valve 3 and the inlet side of the thermal type flow sensor 2.

The invention according to a ninth aspect is the invention according to the second aspect, characterized in that when the difference between a fluid flow rate computed by the pressure type flow rate arithmetic and control unit 7a and a fluid flow rate computed by the thermal type flow rate arithmetic and control unit 7b exceeds a set value, the arithmetic and control unit 7 displays a warning.

According to the present invention, by one pressure type flow control unit, or by one pressure type flow control unit and one thermal type flow control unit, a process gas is supplied to a plurality of process chambers through the plurality of branched pipe passage opening/closing valves 10a, 10n connected in parallel, so that the gas branched flow supplying apparatus can be significantly simplified and compactified in structure. When the plurality of branched pipe passage opening/closing valves 10a, 10n are formed into the same branched pipe passage opening/closing valves and their opening times are set equal to each other, the process gas the flow rate thereof is controlled with high accuracy is branched and supplied at the same flow rate simultaneously to the plurality of process chambers that perform the same process, and the gas branched flow supplying apparatus can be further downsized.

The respective members constituting the gas branched flow supplying apparatus are integrally assembled in one body, so that the gas branched flow supplying apparatus can be significantly downsized.

Further, automatic opening/closing control of the respective branched pipe passage opening/closing valves 10a, 10n is performed from the arithmetic and control unit, so that the process gas can be supplied only to an arbitrary branched pipe passage (or passages), and the branched pipe passage to which the gas is supplied can be easily switched one another.

In addition, a thermal type flow control unit is provided, so that the flow rate of even a process gas under the non-critical expansion condition can be controlled by the thermal type flow control unit with high accuracy, and even during flow control by the pressure type flow control unit under the critical expansion condition, checking, etc., of the actual flow rate can be arbitrarily performed by using the thermal type flow control unit.

### BRIEF DESCRIPTION OF THE DRAWINGS

FIG. 1 is an explanatory view showing a basic structure of a gas branched flow supplying apparatus for semiconductor manufacturing equipment according to the present invention.

FIG. 2 is a structural schematic drawing of a gas branched flow supplying apparatus for semiconductor manufacturing equipment according to an embodiment of the present invention.

FIG. 3 is a structural schematic drawing of another gas branched flow supplying apparatus for semiconductor manufacturing equipment according to an embodiment of the present invention.

FIG. 4 is a structural schematic drawing of still another gas branched flow supplying apparatus for semiconductor manufacturing equipment according to an embodiment of the present invention.

FIG. 5 is a structural systematic diagram showing a first example of a gas branched flow supplying apparatus.

FIG. 6 is a structural systematic diagram showing a second example of a gas branched flow supplying apparatus.

FIG. 7 is a structural systematic diagram showing a third example of a gas branched flow supplying apparatus.

FIG. 8 is a structural explanatory view of a conventional pressure type flow control system.

FIG. 9 is a structural explanatory view of a gas branched flow supplying apparatus using the conventional pressure type flow control system.

FIG. 10 is a structural explanatory view of another gas branched flow supplying apparatus using the conventional pressure type flow control system.

FIG. 11 is a schematic diagram of a flow control system using a conventional automatic pressure controller.

### DETAILED DESCRIPTION OF THE PREFERRED EMBODIMENTS

Hereinafter, embodiments of the present invention are described based on the drawings.

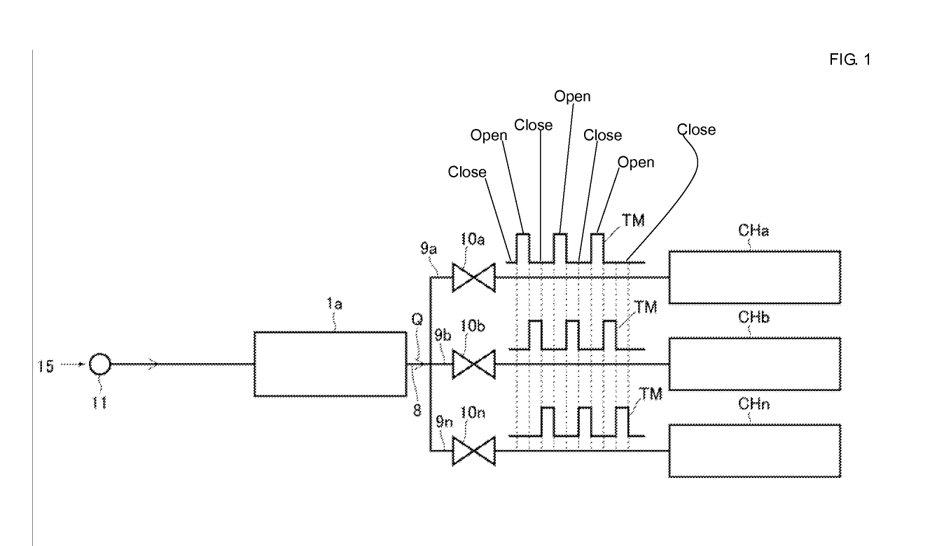

FIG. 1 is an explanatory view showing a basic structure of a gas branched flow supplying apparatus for semiconductor manufacturing equipment according to the present invention. The major portion of the gas branched flow supplying apparatus according to the present invention comprises a pressure type flow control unit 1a and a plurality of branched pipe passage opening/closing valves 10a, . . . , 10n, and as described later, the process gas flow rate Q distributed inside the gas supply main pipe 8 is automatically controlled to a set flow rate by the pressure type flow control unit 1a.

Opening and closing of the branched pipe passage opening/closing valves 10a, . . . , 10n inside the respective branched pipe passages 9a, . . . , 9n joined in parallel are controlled by opening/closing control signals Oda, Odn from the pressure type flow control unit 1a, and as shown in the time chart TM in the drawing, the branched pipe passage opening/closing valves are successively opened for a predetermined time and then closed. That is, the respective branched pipe passage opening/closing valves 10a, 10n are not simultaneously opened, and only either one of the branched pipe passage opening/closing valves is always opened and the other branched pipe passage opening/closing valve (or valves) is held in a closed state. As a result, a process gas is branched and supplied at a flow rate corresponding to Q/n to the process chambers CHa, . . . , CHn connected to the respective branched pipe passages.

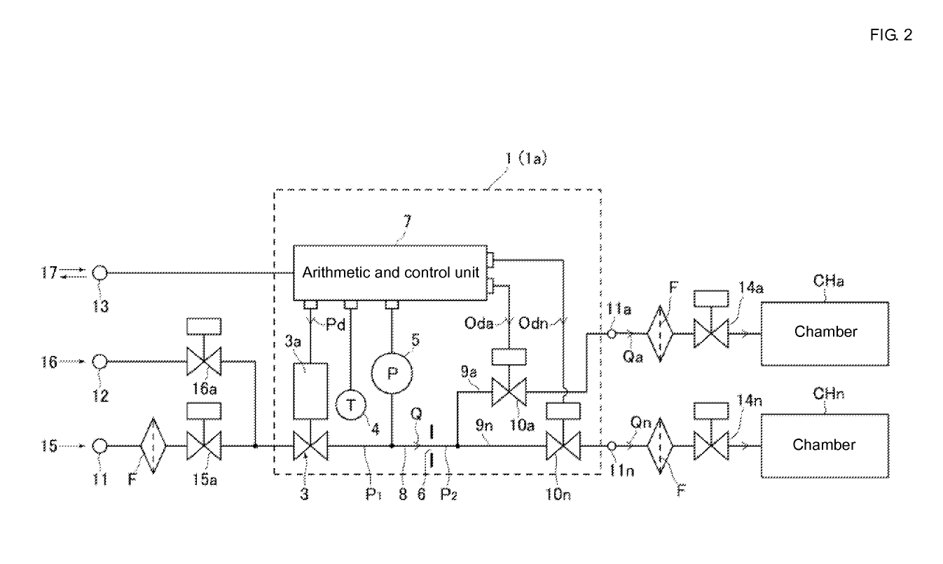

FIG. 2 is a structural explanatory view according to a first embodiment of the gas branched flow supplying apparatus for semiconductor manufacturing equipment according to the present invention, and the major portion of the gas branched flow supplying apparatus consists of a pressure type flow control unit 1a corresponding to a conventional pressure type flow control system.

In FIG. 2, the reference symbol 3 denotes a control valve, 4 denotes a temperature sensor, 5 denotes a pressure sensor, 6 denotes an orifice, and 7 denotes an arithmetic and control unit forming the pressure type flow control unit 1a. The constitution of the pressure type flow control unit 1a is known, therefore, description thereof is omitted here.

The respective branched pipe passage opening/closing valves 10a, 10n are normally-closed type electromagnetic opening/closing valves or piezoelectric element driving valves, and are opened by energization, and are closed by an elastic force of a spring in response to dissipation of a drive voltage.

In the case of the electromagnetic opening/closing valves, valves that can be switched from full closing to full opening at a high speed in at least 0.005 seconds or less when the gas pressure is 1 MPa and the diameter is 10 mm, and can be switched from full opening to full closing in 0.005 seconds or less, are preferably used.

In the present embodiment, as the electromagnetic opening/closing valves, solenoid opening/closing type electromagnetic valves made by Fujikin Incorporated and disclosed in International Publication No. WO 98/25062 are used, and as the piezoelectric element driving valves, piezoelectric element driving type electric control valves made by Fujikin Incorporated and disclosed in Japanese Published Unexamined Patent Application No. 2008-249002 are used. The electromagnetic opening/closing valves and piezoelectric element driving valves themselves are known, therefore, detailed descriptions thereof are omitted.

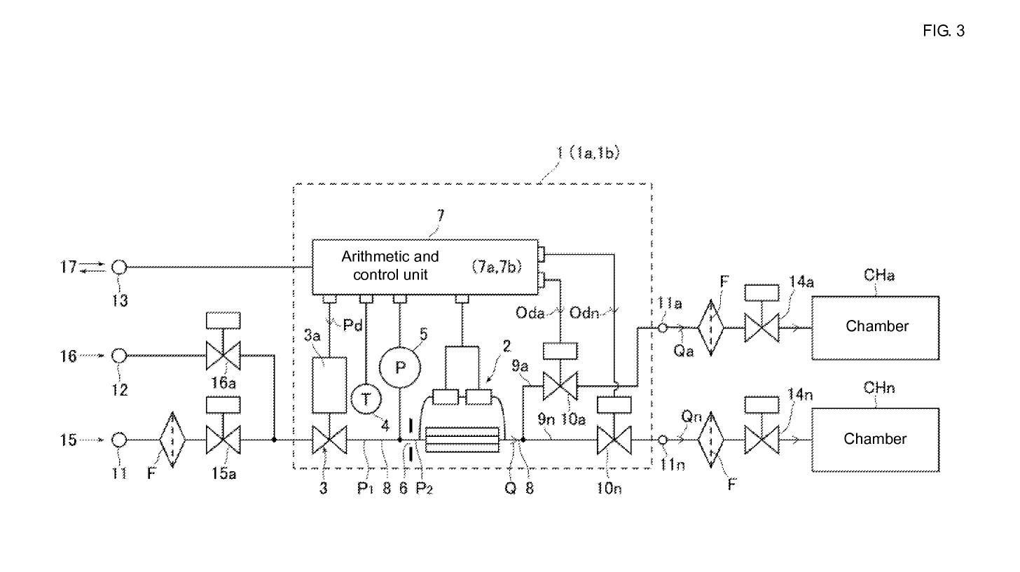

FIG. 3 is a structural explanatory view of a second embodiment of a gas branched flow supplying apparatus for semiconductor manufacturing equipment according to the present invention, and this gas branched flow supplying apparatus 1 comprises two portions of a pressure type flow control unit 1a and a thermal type flow control unit 1b.

That is, the gas branched flow supplying apparatus 1 includes a thermal type flow sensor unit 2 forming the thermal type flow control unit 1b, a control valve 3 forming the pressure type flow control unit 1a, a temperature sensor 4, a pressure sensor 5, an orifice 6, an arithmetic and control unit 7 forming an arithmetic and control unit 7a of the pressure type flow control unit 1a and an arithmetic and control unit 7b of the thermal type flow control unit 1b, and a gas supply main pipe 8, etc., and when the gas distributed through the orifice 6 is under the critical expansion condition, for example, in a case where the gas is O₂ or N₂ gas and the upstream side pressure P₁ and the downstream side pressure P₂ of the orifice 6 satisfies the relationship of P₁/P₂>2, while flow control of a total flow rate Q is performed by the pressure type flow control unit 1a, the respective branched pipe passage opening/closing valves 10a, 10n are successively opened for a predetermined time and then closed by opening/closing control signals Oda, Odn from the pressure type flow control unit 1a as shown in the time chart TM of FIG. 1.

The respective branched pipe passage opening/closing valves 10a, 10n do not open simultaneously, and only either one of the branched pipe passage opening/closing valves is always opened and the other branched pipe passage opening/closing valve (or valves) is held in a closed state. As a result, to the process chambers CHa, . . . , CHn connected to the branched pipe passages, respectively, process gas Qa, . . . , Qn at flow rates corresponding to Q/n are branched and supplied.

When the gas distributed through the orifice 6 is out of the critical expansion condition, while the process gas flow rate Qn is controlled by the thermal type flow control unit 1b, the respective branched pipe passage opening/closing valves 10a, . . . , 10n are successively opened for a predetermined time and then closed according to the time chart TM of FIG. 1 in the same manner as described above, and accordingly, branched gas at the flow rates Qa, . . . , Qn are supplied to the respective chambers CHa, . . . , CHn.

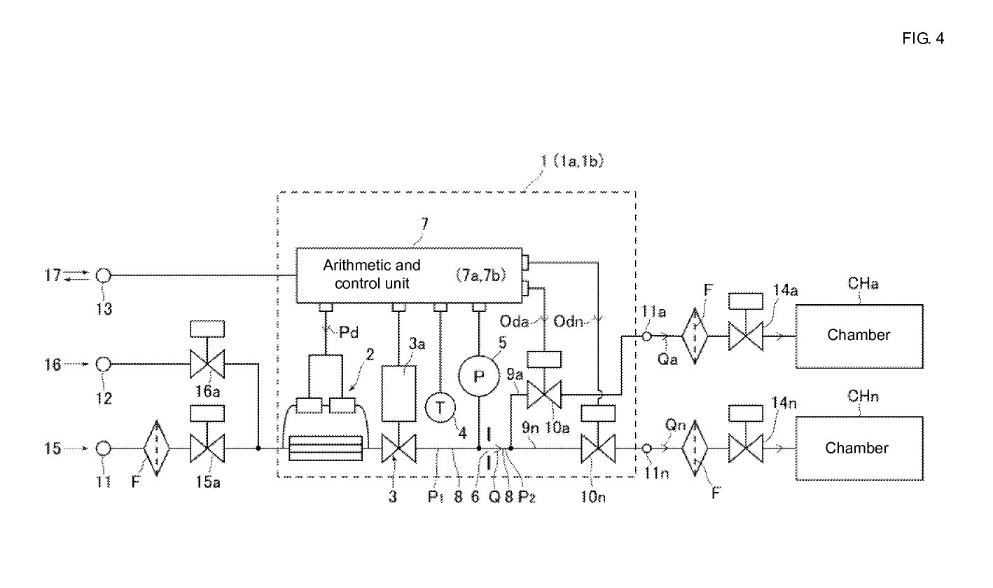

FIG. 4 is a constitution explanatory view according to a third embodiment of the present invention, and except that the position of the thermal type flow sensor 2 in the second embodiment is moved to the upstream side of the control valve 3, the constitution is exactly the same as in the case of FIG. 1.

In FIG. 3 and FIG. 4 described above, the reference symbol 3a denotes a piezoelectric type valve drive unit, 8 denotes a gas supply main pipe, 9a, 9n denote branched pipe passages, 10a, 10n denote branched pipe passage opening/closing valves, 11 denotes a process gas inlet, 11a, 11 n denote branched gas flow outlets, 12 denotes a purge gas inlet, 13 denotes a signal input-output terminal, F denotes a filter, 14a, 14n denote automatic opening/closing valves, 15 denotes a process gas, 15a denotes an automatic opening/closing valve, 16 denotes a purge gas, 16a denotes an automatic opening/closing valve, and 17 denotes an input-output signal. The notation Xa, Xn, as used in this specification and drawings. signifies that any number of branched lines n may be used and that the corresponding parts a . . . n would need to be duplicated for each line.

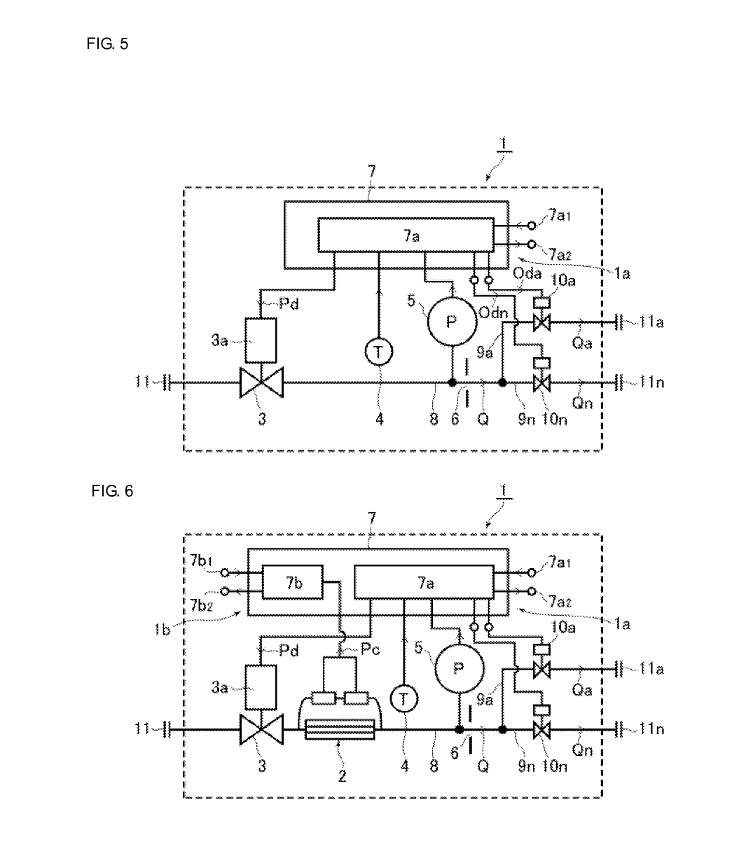

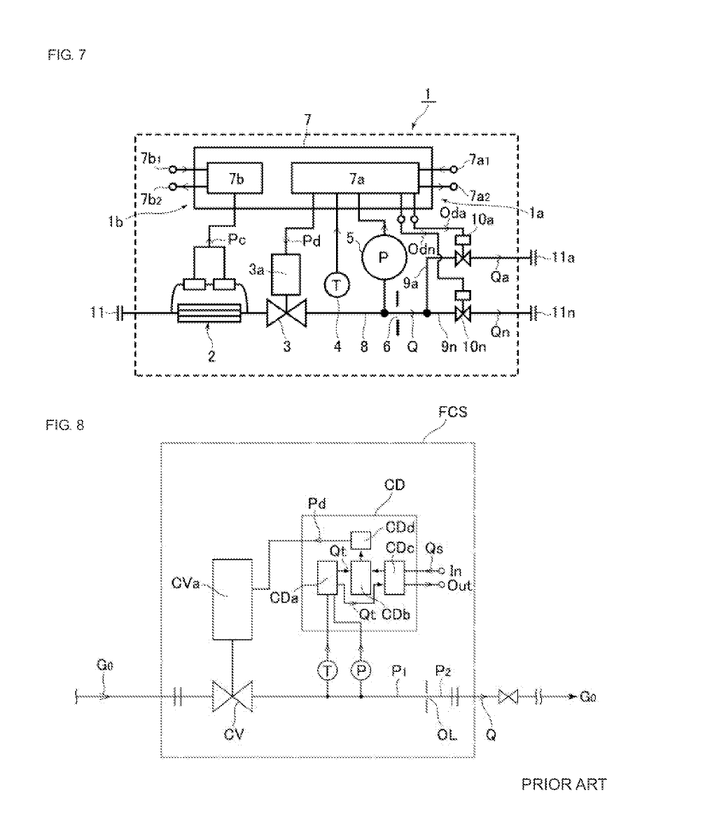

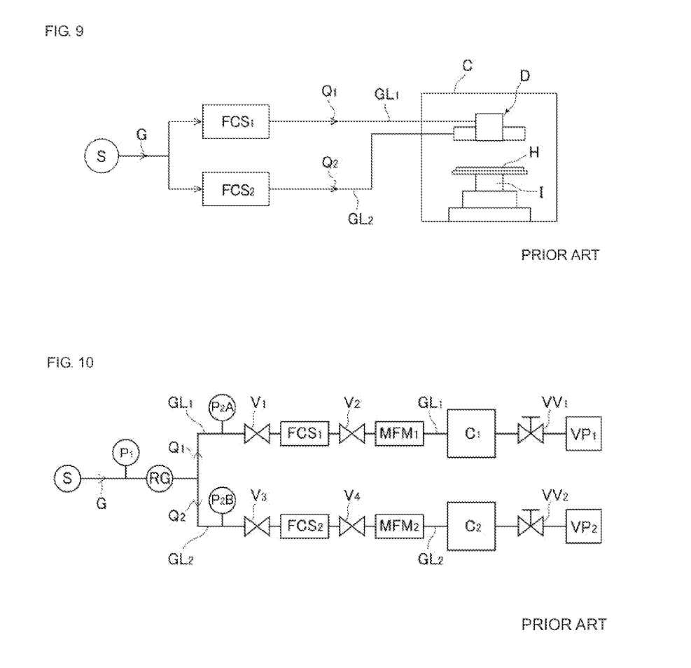

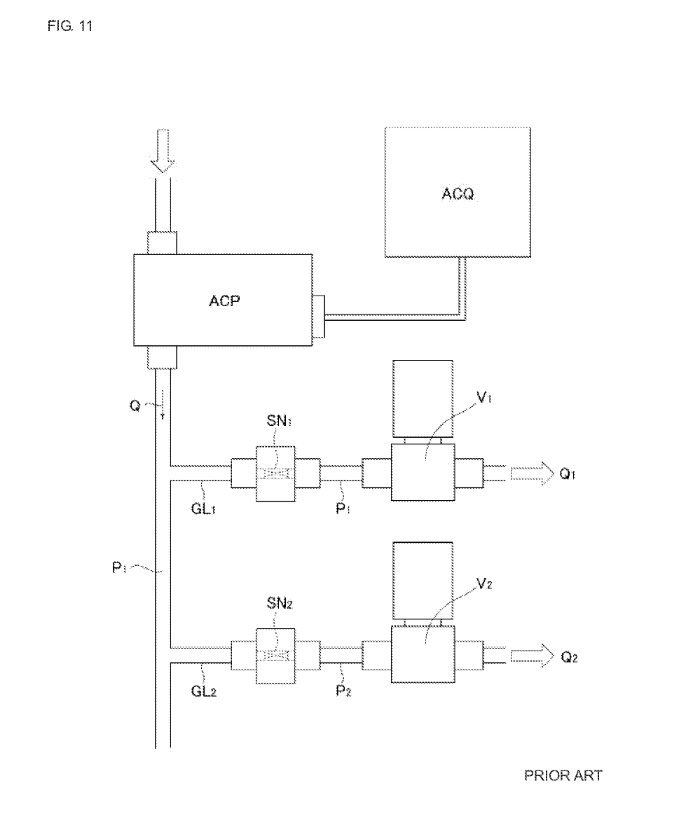

FIG. 5 shows a first example of a gas branched flow supplying apparatus 1 used in the present invention, and the gas branched flow supplying apparatus 1 is constituted by using a pressure type flow control unit 1a as a main body.

FIG. 6 shows a second example of a gas branched flow supplying apparatus used in the present invention, and the gas branched flow supplying apparatus 1 consists of two portions of the pressure type flow control unit 1a and the thermal type flow control unit 1b.

The pressure type flow control unit 1a includes a control valve 3, a temperature sensor 4, a pressure sensor 5, a plurality of orifices 6, and a pressure type flow rate arithmetic and control unit 7a forming an arithmetic and control unit 7.

The thermal type flow control unit 1b includes a thermal type flow sensor 2 and a thermal type flow rate arithmetic and control unit 7b forming the arithmetic and control unit 7.

The pressure type flow control unit 1a includes, as described above, the control valve 3, the temperature sensor 4, the pressure sensor 5, the orifice 6, and the pressure type flow rate arithmetic and control unit 7a, etc., and a flow rate setting signal is output from an input terminal 7a₁, and a flow rate output signal of a total process gas flow rate distributed through the orifice 6 (that is, a process gas flow rate Q distributed through the gas supply main pipe 8) computed by the pressure type flow control unit 1a is output from the output terminal 7a₂.

In the present example, the number of branched flow supply passages is two, so that two branched pipe passage opening/closing valves 10a, 10n are provided, however, normally, the number of branched flow supply passages (that is, the number of branched pipe passage opening/closing valves) is two or more.

Preferably, the diameters and opening times of the respective branched pipe passage opening/closing valves 10a, 10n, that is, the time chart TM of FIG. 1 is appropriately determined according to the required gas supply flow rates to the respective process chambers CHa, . . . , CHn, however, the diameters of the respective branched pipe passage opening/closing valves 10a, . . . , 10n are set equal to each other so that the branched gas Qa, . . . , Qn at the same flow rate are supplied to the respective process chambers CHa, . . . , CHn.

The pressure type flow control unit 1a itself using the orifice 6 is a known technology as described in Japanese Patent No. 3291161, etc., and a flow rate of a fluid distributed through the orifice under the critical expansion condition is computed by the pressure type flow rate arithmetic and control unit 7a based on a pressure detected by the pressure detection sensor 5, and a control signal Pd in proportion to the difference between a set flow rate signal input from the input terminal 7a₁ and the computed flow rate signal is output to a valve drive unit 3a of the control valve 3.

The constitutions of the pressure type flow control unit 1a and the flow rate arithmetic and control unit 7a thereof are known, therefore, detailed descriptions thereof are omitted here.

It is a matter of course that the pressure type flow control unit 1a is provided with various accessory mechanisms such as a known zero point adjustment mechanism, a flow rate abnormality detection mechanism, and a gas type conversion mechanism (CF value conversion mechanism).

Further, in FIG. 5 and FIG. 6, the reference symbol 11 denotes a process gas inlet, 11a, 11 n denote branched gas flow outlets, and 8 denotes a gas supply main pipe inside the apparatus main body.

The thermal type flow control unit 1b constituting the gas branched flow supplying apparatus consists of the thermal type flow sensor 2 and the thermal type flow rate arithmetic and control unit 7b, and the thermal type flow rate arithmetic and control unit 7b is provided with an input terminal 7b₁ and an output terminal 7b₂. From the input terminal 7b₁, a flow rate setting signal is input, and from the output terminal 7b₂, a flow rate signal (actual flow rate signal) detected by the thermal type flow sensor 2 is output.

The thermal type flow control unit 1b itself is known, therefore, description thereof is omitted here. In the present example, as the thermal type flow control unit 1b, one installed in the FCS-T1000 series made by Fujikin Incorporated is used.

As a matter of course, between the thermal type flow rate arithmetic and control unit 7b and the pressure type flow rate arithmetic and control unit 7a, inputs and outputs of the actual flow rate signal and computed flow rate signal are appropriately performed, and whether the signals are different or equal is monitored or the amount of the difference between the signals is monitored, or a warning can be issued when the difference between the signals exceeds a predetermined value although these are not shown in FIG. 6.

FIG. 7 shows a third example of the gas branched flow supplying apparatus 1 according to the present invention in which the attaching positions of the control valve 3 and the thermal type flow sensor 2 are reversed to that in the first example.

It is also possible that a pressure sensor is separately provided on the downstream side of the orifice 6 so that whether or not the fluid distributed through the orifice 6 is under the critical expansion condition is monitored and a warning is issued, and flow control is automatically switched from control by the pressure type flow control unit 1a to control by the thermal type flow control unit 1b although these are not shown in FIG. 6 or FIG. 7.

Further, it is a matter of course that the branched pipe passage opening/closing valves 10a, 10n are appropriately driven to open and close by signals from the arithmetic and control unit 7.

In the embodiment shown in FIG. 3 and FIG. 4, the positions of the thermal type flow sensor 2 and the control valve 3 are reversed to each other, however, it was confirmed through tests that, to realize more highly accurate flow control by reducing the influences of pressure fluctuation, etc., on the supply source side of the process gas 15, the constitution (FIG. 3 and FIG. 5) in which the thermal type flow sensor 2 is disposed on the downstream side of the control valve 3 is preferable.

In the embodiments and examples shown in FIG. 1 to FIG. 7, the attaching positions (detection positions) of the temperature sensor 4 and the pressure sensor 5 are changed, respectively, however, it was confirmed through tests that the flow control accuracy, etc., hardly fluctuate according to the attaching positions of the temperature sensor 4 and the pressure sensor 5, and the attaching position of the temperature sensor 4 may be any position on the gas supply main pipe 8 as long as the attaching position is on the downstream side of the control valve 3 or the thermal type flow sensor 2.

Further, in FIG. 5 to FIG. 7, the control valve 3, the temperature sensor 4, the pressure sensor 5, the orifice 6, the thermal type flow sensor 2, the gas supply main pipe 8, the branched pipe passages 9a, 9n, the branched pipe passage opening/closing valves 10a, 10n, the process gas inlet 11, and the branched gas flow outlets 11a, 11n, etc., are shown in a state where they are independent of each other, however, in actuality, the respective members described above forming the pressure type flow control unit 1a and the thermal type flow control unit 1b are integrally formed, assembled and fixed in one main body (not illustrated).

Next, operation of the gas branched flow supplying apparatus according to the present invention is described. Referring to FIG. 3 to FIG. 7, first, the inside of the gas branched flow supplying apparatus 1 is purged by using the purge gas 16, and after purging is finished, the opening/closing valves 15a and 16a are closed and the branched pipe passage opening/closing valves 10a, 10n are opened, and the insides of the chambers CHa, CHn are decompressed by a vacuum pump or the like (not illustrated) connected to each of the chambers CHa, CHn. In addition, a set flow rate signal is input from the input terminal 7a₁ of the pressure type flow rate arithmetic and control unit 7a of the arithmetic and control unit 7, and a predetermined set flow rate signal is also input into the input terminal 7b₁ of the thermal type flow rate arithmetic and control unit 7b.

Thereafter, by opening the opening/closing valve 15a on the process gas supply side and operating the pressure type flow rate arithmetic and control unit 7a, the control valve 3 is opened, and through the gas supply main pipe 8, the branched pipe passage opening/closing valves 10a, 10n, and the orifices 6a, 6n, branched gas, the total flow rate Q of which is Q=Qa+Qn corresponding to the set flow rate signal are supplied to each of the process chambers CHa, CHn from the branched gas flow outlets 11a, 11n.

The diameter of the orifice 6 is determined in advance based on the orifice primary side pressure P₁ and the required flow rate Q=Qa, Qn, and by controlling the orifice primary side pressure P₁ by adjustment of the opening degree of the control valve 3, the total flow rate Q=Qa+Qn is controlled to the set flow rate.

The gas branched flow supplying apparatus 1 according to the present invention is mainly used to supply a process gas to the process chambers CHa, CHn that perform the same process. Therefore, the diameters of the branched pipe passage opening/closing valves 10a, 10n are normally selected to be the same diameter. The valve opening times in the time chart TM of the branched pipe passage opening/closing valves 10a, 10n are appropriately set according to the branched flow supply amounts required for the process chambers CHa, CHn.

When the critical expansion condition is satisfied between the primary side pressure P₁ and the secondary side pressure P₂ of the orifice 6, flow control is performed by the pressure type flow control unit 1a. The thermal type flow control unit 1b is operated when necessary, and the actual flow rate of the process gas Q distributed inside the gas supply main pipe 8 is checked and displayed, etc.

On the other hand, according to the pressure conditions, etc., on the process chamber CHa, CHn side, when the process gas flow distributed through the orifice 6 is out of the critical expansion condition (P₁/P₂ 2), the flow control by the pressure type flow control unit 1a is automatically switched to flow control by the thermal type flow control unit 1b, and by operating the thermal type flow rate arithmetic and control unit 7b instead of the pressure type flow rate arithmetic and control unit 7a, the process gas flow rate is controlled.

As a result, even in a case where the process gas flow distributed through the orifice 6 is out of the critical expansion condition, highly accurate flow control can be performed regardless of the pressure condition of P₁/P₂ described above.

In the respective examples described above, description is given on the assumption that the process gas flow is supplied to all of the plurality of branched pipe passages 9a, 9n, however, as a matter of course, the gas may be supplied only to a necessary branched pipe passage (or passages).

Further, in the respective examples described above, both of the pressure type flow control unit 1a and the thermal type flow control unit 1b are provided, however, it is certainly possible that the thermal type flow control unit 1b is omitted and the gas branched flow supplying apparatus is provided with only the pressure type flow control unit 1a, and in this case, the gas branched flow supplying apparatus can be further downsized and compactified.

### INDUSTRIAL APPLICABILITY

The present invention can be widely applied not only to gas branched flow supplying equipment for semiconductor manufacturing equipment, but also to gas branched flow supplying equipment for chemical goods production equipment, etc.

### DESCRIPTION OF REFERENCE SYMBOLS

TM: time chart of operations of respective branched pipe passage opening/closing (opening and closing) valves
CHa, CHn: process chamber
Q: total process gas flow rate
Qa, Qn: branched gas
P₁: orifice upstream side pressure
P₂: orifice downstream side pressure
Oda, Odn: opening/closing (opening and closing) control signals of respective branched pipe passage opening/closing (opening and closing) valves
1: gas branched flow supplying apparatus for semiconductor manufacturing equipment
1a: pressure type flow control unit
1b: thermal type flow control unit
2: thermal type flow sensor
3: control valve
3a: piezoelectric type valve drive unit
4: temperature sensor
5: pressure sensor
6: orifice
7: arithmetic and control unit
7a: pressure type flow rate arithmetic and control unit
7b: thermal type flow rate arithmetic and control unit
8: gas supply main pipe
9a, 9n: branched pipe passage
10a, 10n: branched pipe passage opening/closing (opening and closing) valve
11: process gas inlet
11a, 11n: branched gas flow outlet
12: purge gas inlet
13: input-output signal terminal
14a, 14n: opening/closing (opening and closing) valve
15: process gas
15a: opening/closing (opening and closing) valve
16: purge gas
16a: opening/closing valve
17: input-output signal

1. A gas branched flow supplying apparatus for semiconductor manufacturing equipment comprising:
a control valve forming at least a portion of a pressure type flow control unit connected to a process gas inlet;
a gas supply main pipe communicatively connected to a downstream side of the control valve;
an orifice provided in the gas supply main pipe on the downstream side of the control valve;
a plurality of branched pipe passages connected in parallel on a downstream side of the gas supply main pipe;
a branched pipe passage opening and closing valve interposed in each respective branched pipe passage;
a pressure sensor provided in a process gas passage between the control valve and the orifice;
a branched gas flow outlet provided on an outlet side of each respective branched pipe passage; and
an arithmetic and control unit operably connected to have input therein a pressure signal from the pressure sensor, and arranged to compute a total flow rate of process gas distributed through the orifice and wherein the arithmetic and control unit is further operably connected to outputs a control signal to a valve drive unit operably connected to operate the control valve to open and close in a direction in which the difference between the computed flow rate value and a set flow rate value decreases, and wherein the arithmetic and control unit is further operably connected to output control signals to the plurality of branched pipe passage opening and closing valves to successively open the respective branched pipe passage opening and closing valves for a predetermined time and then close the valves, wherein the gas branched flow supplying apparatus is arranged to performs flow control of process gas distributed through the orifice with the pressure type flow control unit, and branches and supplies process gas by opening and closing the branched pipe passage opening and closing valves.

2. A gas branched flow supplying apparatus for semiconductor manufacturing equipment comprising:
a control valve forming at least a portion of a pressure type flow control unit connected to a process gas inlet;
a thermal type flow sensor forming at least a portion of a thermal type flow control unit connected to a downstream side of the control valve;
a gas supply main pipe communicatively connected to a downstream side of the thermal type flow sensor;
a plurality of branched pipe passages connected in parallel on a downstream side of the gas supply main pipe;
a branched pipe passage opening and closing valves interposed in each respective branched pipe passage;
an orifice provided in the gas supply main pipe on a downstream side of the control valve;
a temperature sensor provided near a process gas passage between the control valve and the orifice;
a pressure sensor provided in the process gas passage between the control valve and the orifice;
a branched gas flow outlet provided on an outlet side of each branched pipe passage; and
an arithmetic and control unit, including
a pressure type flow rate arithmetic and control unit operably connected to have input therein a pressure signal from the pressure sensor and a temperature signal from the temperature sensor, and wherein the pressure type flow rate arithmetic and control unity is arranged to compute a total flow rate of the process gas distributed through the orifice and outputs a control signal to a valve drive unit operably connected to operate the control valve to open and close in a direction in which the difference between the computed flow rate value and a set flow rate value decreases, and wherein the pressure type flow rate arithmetic and control unity is further arranged to output control signals to the branched pipe passage opening and closing valves to successively open the respective branched pipe passage opening and closing valves for a predetermined time and then close the valves, and
a thermal type flow rate arithmetic and control unit operably connected to have input therein a flow rate signal from the thermal type flow sensor, and wherein the thermal type flow rate arithmetic and control unit is arranged to compute and display a total flow rate of the process gas distributed through the gas supply main pipe using the flow rate signal, wherein the gas branched flow supplying apparatus is arranged to performs process gas flow control with the pressure type flow control unit when the process gas flow distributed through the orifice is a gas flow satisfying the critical expansion condition and wherein the gas branched flow supplying apparatus is arranged to performs process gas flow control by the thermal type flow control unit when the process gas flow is a gas flow not satisfying the critical expansion condition, and wherein the gas branched flow supplying apparatus branches and supplies the process gas by opening and closing the branched pipe passage opening and closing valves.

3. The gas branched flow supplying apparatus for semiconductor manufacturing equipment according to claim 1, wherein the opening times of the plurality of branched pipe passage opening and closing valves are set equal to each other, and process gas at the same flow rate is supplied to each respective branched pipe passage.

4. The gas branched flow supplying apparatus for semiconductor manufacturing equipment according to claim 1, wherein the process gas is distributed through only one of the plurality of branched pipe passages.

5. The gas branched flow supplying apparatus for semiconductor manufacturing equipment according to claim 1, wherein the control valve, the orifice, the pressure sensor, the branched pipe passages, the branched pipe passage opening and closing valves, and the gas supply main pipe are integrally formed and assembled in one body.

6. The gas branched flow supplying apparatus for semiconductor manufacturing equipment according to claim 2, wherein the control valve, the thermal type flow sensor, the orifice, the pressure sensor, the temperature sensor, the gas supply main pipe, the branched pipe passages, and the branched pipe passage opening and closing valves are integrally formed and assembled in one body.

7. The gas branched flow supplying apparatus for semiconductor manufacturing equipment according to claim 2, wherein the flow rate of the process gas is controlled by the pressure type flow control unit, and the actual flow rate of the process gas is displayed by the thermal type flow control unit.

8. The gas branched flow supplying apparatus for semiconductor manufacturing equipment according to claim 2, wherein the pressure sensor is provided between the outlet side of the control valve and the inlet side of the thermal type flow sensor.

9. The gas branched flow supplying apparatus for semiconductor manufacturing equipment according to claim 2, wherein when the difference between a fluid flow rate computed by the pressure type flow rate arithmetic and control unit and a fluid flow rate computed by the thermal type flow rate arithmetic and control unit exceeds a set value, the arithmetic and control unit displays a warning.

10. The gas branched flow supplying apparatus for semiconductor manufacturing equipment according to claim 2, wherein the opening times of the plurality of branched pipe passage opening and closing valves are set equal to each other, and process gas at the same flow rate is supplied to each respective branched pipe passage.

11. The gas branched flow supplying apparatus for semiconductor manufacturing equipment according to claim 2, wherein the process gas is distributed through only one of the plurality of branched pipe passages.
